(19) United States
(12) Patent Application Publication
(10) Pub. No.: US 2021/0094092 A1
(43) Pub. Date: Apr. 1, 2021

(54) COMPONENT PART FOR ALUMINUM DIE-CASTING MOLD

(71) Applicant: AISIN SEIKI KABUSHIKI KAISHA, Kariya-shi (JP)

(72) Inventors: Chengji JIN, Kariya-shi (JP); Hideo TACHIKAWA, Nisshin-shi (JP); Tatsuya HAGINO, Kariya-shi (JP); Hodo SUZUKI, Kariya-shi (JP)

(73) Assignee: AISIN SEIKI KABUSHIKI KAISHA, Kariya-shi (JP)

(21) Appl. No.: 16/495,189

(22) PCT Filed: Aug. 2, 2018
(86) PCT No.: PCT/JP2018/029080

§ 371 Date: Sep. 18, 2019

(30) Foreign Application Priority Data
Aug. 25, 2017 (JP) 2017-162512

(51) Int. Cl. B22D 17/22; B22C 3/00

(52) U.S. Cl. CPC B22D 17/2218; B22C 9/06; B22C 3/00

(57) ABSTRACT

A component part for an aluminum die-casting mold has an exposed surface that is a surface exposed to a cavity part of the aluminum die-casting mold and has diamond-like carbon coating formed at least on a part of the exposed surface, wherein the diamond-like carbon coating contains hydrogen in a content rate of 10 at % or more and 30 at % or less. The diamond-like carbon coating may further contain silicon in a content rate of less than 10 at %. Preferably, the content rate of silicon in the diamond-like carbon coating is 0.5 at % or more and 7 at % or less. Thereby, a component part for an aluminum die-casting mold which has excellent seizure resistance against molten metal containing aluminum can be provided.

### TECHNICAL FIELD

The present invention relates to a component part for an aluminum die-casting mold. More specifically, the present invention relates to a component part for an aluminum die-casting mold which has excellent seizure resistance against molten metal containing aluminum.

### BACKGROUND ART

Seizure in a die-casting method is a phenomenon in which injected aluminum alloy reacts and fusionbonds with the surface of a mold or core pin, etc., and may lead to problems, such as deterioration of dimensional accuracy, productivity and appearance quality of a die-casting product, for example. Therefore, in the art, for the purpose of reducing the reaction and fusionbond of aluminum alloy, measures against seizure, such as enhancement of cooling of the inside and/or surface of the mold, application of a release agent and a surface treatment, have been widely performed, for example.

As a specific example of the surface treatment as mentioned above, formation of a surface treated layer which contains at least one or more compounds among oxide, carbide, nitride and carbonitride, for example, on the surface of the mold by a procedure, such as physical vapor deposition (PVD) and chemical vapor deposition (CVD), can be mentioned, for example. Moreover, contact with molten metal can be reduced to suppress seizure, by forming fine irregularity on the surface of such a surface treated layer through with procedure, such as shot peening, for example. Alternatively, durability of a mold can also be improved by nitriding the surface of a substrate (refer to the Patent Document 1 (PTL1), for example).

However, a surface treated layer formed by a procedure, such as PVD and CVD, as mentioned above cannot sufficiently prevent the reaction, of aluminum and a mold, and its suppression effect against seizure is small. Moreover, when fine irregularity is formed on the surface of a surface treated layer by a procedure, such as shot peening, increase in cost associated with increase in the number of manipulation processes is caused. Furthermore, there is also a possibility that damage, such as galling, may occur on the surface of a die-casting product when releasing the die-casting product out of a mold and thereby seizure may occur.

On the other hand, a technology, in which friction of a sliding surface is lowered even when the surface roughness of the sliding surface is large by forming a sliding layer which contains amorphous carbon having an sp2 hybrid orbital, hydrogen and silicon in a specific composition ratio on the sliding surface of a substrate, sliding the sliding surface in contact with an target object to wear (abrade) the sliding surface to be smoothed, and making the sliding surface adsorb moisture in an atmosphere by Si—OH generated on the surface, has been proposed (refer to the Patent Document 2 (PTL2), for example).

However, the above-mentioned technology will lower friction of a sliding surface of a frictional part (slide member), but will not reduce seizure in a die-casting mold as mentioned above. Specifically, the amorphous carbon film which constitutes the above-mentioned sliding layer contains 30 at % or more of hydrogen, and thereby abrasion resistance is lowered and smoothing of the sliding surface is attained. However, when abrasion resistance is reduced in this way, since the sliding layer is ground by eutectic crystal Si contained in aluminum alloy to disappear at the time of releasing a product out of a mold in a die-casting process, for example, effect for suppressing the reaction of the aluminum alloy and a substrate cannot be maintained over a long period of time. Moreover, when the content rate of silicon in the amorphous carbon film is 10 at % or more, there is a possibility that seizure may be generated due to the reaction of aluminum and silicon in a die-casting process to lead to problems, such as deterioration of dimensional accuracy of a die-casting product as mentioned above.

### CITATION LIST

### Patent Literature

[PTL1] Japanese Patent Application Laid-Open (kokai) No. 2012-183548

[PTL2] Japanese Patent Application Laid-Open (kokai) No. 2007-023356

### SUMMARY OF INVENTION

### Technical Problem

As mentioned above, in the art, a technology which can provide a component part for an aluminum die-casting mold which has excellent seizure resistance against molten metal containing aluminum has been demanded. Namely, one objective of the present invention is to provide a component part for an aluminum die-casting mold which has excellent seizure resistance against molten metal containing aluminum.

### Solution to Problem

Then, as a result of wholeheartedly research, the present inventor has found out that a component part for an aluminum die-casting mold which has excellent seizure resistance against molten metal containing aluminum can be provided by forming diamond-like carbon (DLC) which contains silicon and hydrogen in specific content rates on the surface of a substrate.

In view of the above, a component part for an aluminum die-casting mold according to the present invention (which may be referred to as a “present invention component part” hereafter) has an exposed surface that is a surface exposed to a cavity part of the aluminum die-casting mold. And, diamond-like carbon coating is formed at least on a part of said exposed surface. Furthermore, the above-mentioned diamond-like carbon coating contains hydrogen in a content rate of 10 at % or more and 30 at % or less.

In the present invention component part, the above-mentioned diamond-like carbon coating may further contain silicon in a content rate of less than 10 at %. Preferably, the content rate of silicon in the above-mentioned diamond-like carbon coating is 0.5 at % or more and 7 at % or less.

### Advantageous Effects of Invention

In accordance with the present-invention, a component part for an aluminum die-casting mold which has excellent seizure resistance against molten metal containing aluminum can be provided.

Other objectives, other features and accompanying advantages of the present invention will be easily understood from the following explanation about various embodiments of the present invention which will be described below referring to drawings.

### BRIEF DESCRIPTION OF DRAWINGS

FIG. 1 is a schematic sectional view for showing a state of a coating formed on the surface of various test, pieces and core pins in Working Example.

FIG. 2 is photographs for showing states of aluminum alloy adhering to the surfaces of the various core pins subjected to evaluation of seizure resistance in Working Example.

FIG. 3 is a schematic graph for showing a relation between number of shots and Al deposit as an evaluation of seizure resistance in Working Example.

### DESCRIPTION OF EMBODIMENTS

### First Embodiment

Hereafter, a component part for an aluminum die-casting mold according to a first embodiment of the present invention (which may be referred to as a “first component part” hereafter) will be explained below referring to drawings.

### <Configuration>

The first component part has an exposed surface that is a surface exposed to a cavity part of an aluminum die-casting mold. The “aluminum die-casting” in this specification includes not only a mold casting process of aluminum, but also a mold casting process of aluminum alloy. Moreover, the first component part is not limited in particular, as long as it is a component part which has an exposed surface that is a surface exposed to a cavity part of an aluminum die-casting mold. As specific examples of such component parts, component parts, which constitute a cavity or core of an aluminum die-casting mold, and component parts, such as a core pin, can be mentioned, for example.

A material which constitutes a substrate of the first component part can be suitably chosen from various materials generally used as materials of component parts for aluminum die-casting mold, according to conditions of a die-casting process (for example, temperature and pressure of molten metal, etc.). As specific examples of such materials, various alloy tool steels for molds including various SKD steels (for example, SKD61, etc.) specified by the JIS (Japanese Industrial Standards) can be mentioned, for example.

And, a diamond-like carbon coating is formed at least on a part of the above-mentioned exposed surface. As well-known to a person skilled in the art, the diamond-like carbon coating is amorphous hard film which mainly consists of allotropes of carbon, and is also referred to as a DLC (Diamond-Like Carbon) coating. The DLC coating does not necessarily cover all the exposed surface of the first component part, and just needs to be formed at least on a part of the exposed surface.

As manufacturing methods of a DLC coating, chemical vapor deposition (CVD) and physical vapor deposition (PVD) can be mentioned, for example. As specific examples of CVD, procedures, such as plasma CVD and thermal CVD (using high-frequency wave, microwave or direct current, etc., for example), can be mentioned, for example. As specific examples of PVD, procedures, such as ion plating (based on direct-current excitation or high-frequency wave excitation), sputtering and laser ablation, can be mentioned, for example. A specifically adopted procedure is suitably chosen according to material of a substrate used as a backing and characteristics required for the DLC film, etc., for example.

Furthermore, in the first component part, the above-mentioned diamond-like carbon coating contains hydrogen in a content rate of 10 at % or more and 30 at % or less. As well-known to a person skilled in the art, the content rate of hydrogen contained in a DLC coating varies depending on raw materials and manufacturing methods, etc., for example. However, the DLC coating which the first component part comprises is prepared such that the content rate of hydrogen is 10 at % or more and 30 at % or less.

When the content rate of hydrogen in the DLC coating which the first component part comprises is less than 10 at %, the DLC coating becomes excessively hard and its toughness becomes insufficient. As a result, it becomes difficult for the DLC coating to bear stress generated due to difference between temperature upon contact with molten metal in a die-casting process and temperature upon application of a release agent (thermal stress), for example, the DLC coating is separated (peeled off) from the exposed surface, and it becomes difficult to maintain seizure resistance against molten metal containing aluminum.

On the other hand, when the content rate of hydrogen in the DLC coating which the first component part comprises exceeds 30 at %, abrasion resistance of the DLC coating becomes insufficient. As a result, the DLC coating is abraded (worn, out) when a product is released out of a mold in a die-casting process, for example, and it becomes difficult to maintain seizure resistance against molten metal containing aluminum. Especially, in a mold casting method of aluminum alloy which contains silicon, like ADC12, etc., for example, there is a high possibility that the sliding layer may be ground by eutectic crystal Si contained in aluminum alloy to disappear.

### <Effects>

As mentioned above, in the first component part, the DLC coating formed at least on a part of the exposed surface that is a surface exposed to a cavity part of an aluminum die-casting mold contains hydrogen in a content rate of 10 at % or more and 30 at % or less. Thereby, both toughness and abrasion resistance which can endure (bear) the thermal stress and abrasion in a die-casting process can be achieved, and seizure resistance against molten metal containing aluminum can be maintained. Namely, in accordance with the first component part, a component part for an aluminum die-casting mold which has excellent seizure resistance against molten metal containing aluminum can be provided.

The effects as mentioned above are presumed to be attained by the following mechanisms. First, it becomes difficult for aluminum to adhere to the exposed surface of the first component part by forming the DLC coating which has composition having little reactivity with aluminum on the exposed surface. Furthermore, even in a case where aluminum has adhered to the exposed surface since the mold-release resistance is higher than the strength of aluminum upon release of a product from a mold, etc., for example, since the exposed surface of the first component part is covered with the DLC coating and aluminum and a substrate do not react, adhesion strength between aluminum and the substrate. For this reason, the aluminum which has adhered to the exposed surface is easily separated (peeled off) in a die-casting process, and seizure of aluminum on the exposed surface is not accumulated (developed and/or grown).

As a result of the above, in accordance with the first component part, seizure in a die-casting process can be reduced as compared with mold parts according to conventional technologies. Therefore, it becomes possible to reduce workloads for maintaining a mold and to manufacture an aluminum casting and/or an aluminum alloy casting which have a satisfactory cast surface with high productivity.

### Second Embodiment

Hereafter, the component part for aluminum die-casting mold according to a second embodiment of the present invention (which may be referred to as a “second component part” hereafter) will be explained.

### <Configuration>

As mentioned above, in accordance with the first component part, the diamond-like carbon (DLC) coating formed at least on a part of the exposed surface contains hydrogen in a predetermined content rate, and thereby both sufficient toughness and abrasion resistance can be attained in the coating to maintain seizure resistance against molten metal containing aluminum. However, oxidization (combustion) of the carbon and hydrogen which constitute the DLC coating may occur depending on the conditions of a die-casting process (for example, temperature of molten metal, etc.). As a result, heat resistance (oxidation resistance) of the coating may become insufficient, and it may become difficult to maintain seizure resistance against molten metal containing aluminum for a long period of time.

Then, the second component part is the above-mentioned first component part, wherein the above-mentioned diamond-like carbon (DLC) coating further contains silicon in a content rate of less than 10 at %.

When the content rate of silicon in the DLC coating which the second component part comprises is 0 (zero) at % (namely, the DLC coating does not contain silicon), heat resistance (oxidation resistance) of the coating may become insufficient and it may become difficult to maintain seizure resistance against molten metal containing aluminum for a long period of time, as mentioned above. On the other hand, when the content rate of silicon in the DLC coating which the second component part comprises is 10 at % or more, there is a possibility that seizure, may be generated due to a reaction of aluminum and silicon and atmospheric oxygen in a die-casting process to lead to problems, such as deterioration of dimensional accuracy of a die-casting product as mentioned above.

The higher the content of silicon in the DLC coating becomes, the higher concern about seizure resulting from the reaction of aluminum and silicon contained in molten metal and atmospheric oxygen becomes, as mentioned above. Therefore, preferably, the content rate of silicon in the above-mentioned diamond-like carbon (DLC) coating is 0.5 at % or more and 7 at % or less. More preferably, the content rate of silicon in the above-mentioned DLC coating is 4 at % or less.

### <Effects>

As mentioned above, in the second component part, the DLC coating formed at least on a part of the exposed surface contains silicon in a content rate of less than 10 at %. Thereby, degradation of heat resistance (oxidation resistance) of the DLC coating resulting from oxidization (combustion) of carbon and hydrogen which constitute the coating and seizure resulting from the reaction of aluminum and silicon contained in molten metal and atmospheric oxygen can be reduced. Namely, in accordance with the second component part, a component part for an aluminum die-casting mold which has further more excellent seizure resistance against molten metal containing aluminum can be provided.

In addition, for the purpose of improving abrasion resistance, for example, the diamond-like carbon (DLC) coating formed at least on a part of the exposed surface of the present invention component part may further contain nitrogen, in addition to the above-mentioned hydrogen. In this case, it is desirable that the content rate of nitrogen in the DLC coating is Sat % or less.

Moreover, it is desirable that the thickness of the DLC coating is 0.2 micrometers or more and less than 20 micrometers. When the thickness of the DLC coating is less than 0.2 micrometers, there is a possibility that continuity of the DLC coating may become insufficient and it may become difficult to secure long term durability of the coating. On the other hand, when the thickness of the DLC coating is not less than 20 micrometers, there is a possibility that adhesion of the coating to a substrate of the present invention component part may become insufficient and it may become difficult to secure long-term durability of the coating, too. More preferably, the thickness of the DLC coating is 0.5 micrometers or more and is less than 15 micrometers.

### Working Example

### <<Preparation of Various Samples>>

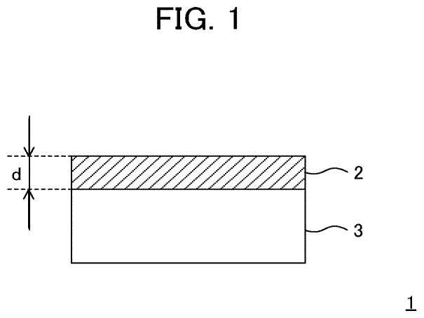

Component parts for an aluminum die-casting mold according to working examples of the present invention will be explained in detail below, referring to drawings. Test pieces and core pins formed of alloy tool steel SKD61 for molds were prepared, and the coatings listed in the following Table 1 were formed on the surfaces thereof. For each of the samples, the coating was formed such that the thickness (d) of the coating was about 3 micrometers, as shown in FIG. 1. FIG. 1 is a schematic sectional view in the vicinity of the coating on the surface (exposed surface) on which the coating was formed in each sample (1), and a part of the coating (2) and the substrate (3) of the sample (1) is illustrated.

TABLE 1

| | | | | | Seizure Resistance | | | Heat Resistance | | |
|---|---|---|---|---|---|---|---|---|---|---|
| | | Composition | | | Al | Peel | | Mass | | |
| | | Si | H | C | Deposit | Force | | Decrease | | Over-All |
| Sample | Coating | [at %] | [at %] | [at %] | [mg] | [kgf] | Evaluation | [mg] | Evaluation | Evaluation |
| CE1 | Nitride | — | — | — | 16 | 14.5 | Poor | — | — | Poor |
| CE2 | Ti—Al—N | — | — | — | 10 | 8.1 | Poor | — | — | Poor |
| CE3 | DLC | 16 | 28 | 56 | 12 | 3.6 | Fair | 0 | Excellent | Fair |
| CE4 | DLC | 7 | 40 | 53 | 14 | 11 | Poor | 0 | Excellent | Poor |
| WE1 | DLC | 0 | 28 | 72 | 1.5 | 2.8 | Excellent | 0.04 | Good | Good |
| WE2 | DLC | 4 | 28 | 68 | 3.6 | 1.8 | Excellent | 0 | Excellent | Excellent |
| WE3 | DLC | 5 | 28 | 67 | 4.9 | 2.5 | Excellent | 0 | Excellent | Excellent |
| WE4 | DLC | 7 | 28 | 65 | 6.8 | 0.3 | Excellent | 0 | Excellent | Excellent |

As shown in Table 1, as for the sample CE1 according to a comparative example, nitride coating was formed on the surface of a test piece and a core pin by a salt bath nitriding method (the surface was hardened by a salt bath nitriding method). As for the sample CE2 according to another comparative example, Ti—Al—N system coating was formed on the surface of a test piece and a core pin by a low temperature PVD. These samples CE1 and CE2 are comparative examples with a surface treatment and coating conventionally used in a die-casting mold of aluminum and aluminum alloy.

On the other hand, as for the samples CE3 and CE4 according to further comparative examples and the samples WE1 to WE4 according to the working examples of the present invention, diamond-like carbon (DLC) coating was formed on the surface of a test piece and a core pin by a plasma CVD, respectively. However, compositions of the DLC coatings formed in these samples differs from each other, as shown in Table 1. Specifically, as for the samples CE3 and CE4 according to the comparative examples, the content rates of silicon (Si) and hydrogen (H) are deviated from suitable ranges to be excessive, respectively. On the other hand, as for the samples WE1 to WE4 according to the working examples, the content rates of both silicon (Si) and hydrogen (H) are within suitable ranges, respectively.

### <<Evaluation of Various Samples>>

### <Seizure Resistance>

The above-mentioned various core pins of the samples CE1 to CE4 according to the comparative examples and the samples WE1 to WE4 according to the working examples of the present invention were set in an aluminum die-casting machine, and die-castings of aluminum alloy ADC12 were casted at temperature of 650° C. and pressure of 500 t/cm², 90 shots for each of these samples.

Then, for each of these various core pins, a mass variation (amount of increase) of the core pin before and behind the above-mentioned 90 shots of the die-casting process was calculated as an amount of aluminum (Al) deposit. Moreover, a fixture for measurement was stuck with a bonding agent (adhesive) on a region to which aluminum adhered, the fixture and core pin were subjected to a tensile test by a tension testing machine, and a breaking force was acquired as peel force, respectively. The Al deposit and peel force measured in these ways are also listed in Table 1.

The Al deposit was evaluated as “excellent” when being 7 mg or less, as “good” when being 10 mg or less, as “fair” when being 13 mg or less, and as “poor” when being more than 13 mg. The peel force was evaluated as “excellent” when being 3 kgf or less, as “good” when being 5 kgf or less, as “fair” when being 7 kgf or less, and as “poor” when being more than 7 kgf. Then, as an evaluation result of seizure resistance, the lower one of the evaluation results of Al deposit and peel force was adopted.

As shown in Table 1, as for the Al deposit, it has been confirmed that it is remarkably reduced in the samples WE1 to WE4 according to the working examples of the present invention, as compared with that in the samples CE1 to CE4 according to the comparative examples. Also as for the peel force, as a general tendency, it has been confirmed that it is remarkably reduced in the samples WE1 to WE4 according to the working examples of the present invention, as compared with that in the samples CE1 to CE4 according to the comparative examples. More particularly, in the samples comprising the DLC coating, smaller peel force was presented as compared with the samples comprising the conventionally used coatings. However, as for the sample CE3 according to the comparative example, it was considered that abrasion resistance of the DLC coating became insufficient, the DLC coating was abraded (worn out) and its seizure resistance could not be maintained since the content rate of hydrogen (H) in the composition of the DLC coating was higher than the suitable range although the sample comprised the DLC coating.

From the above, the evaluation results of seizure resistance were “excellent” for all of the samples WE1 to WE4 according to the working examples of the present invention, while those were “poor” for all of the samples CE1, CE2 and CE4 according to the comparative examples and that was “fair” only for the sample CE3 according to the comparative example. Thus, it has been confirmed that the present invention component part presents more excellent seizure resistance as compared with a component part for an aluminum die-casting mold according to a conventional technology (which may be referred to as a “conventional component part” hereafter).

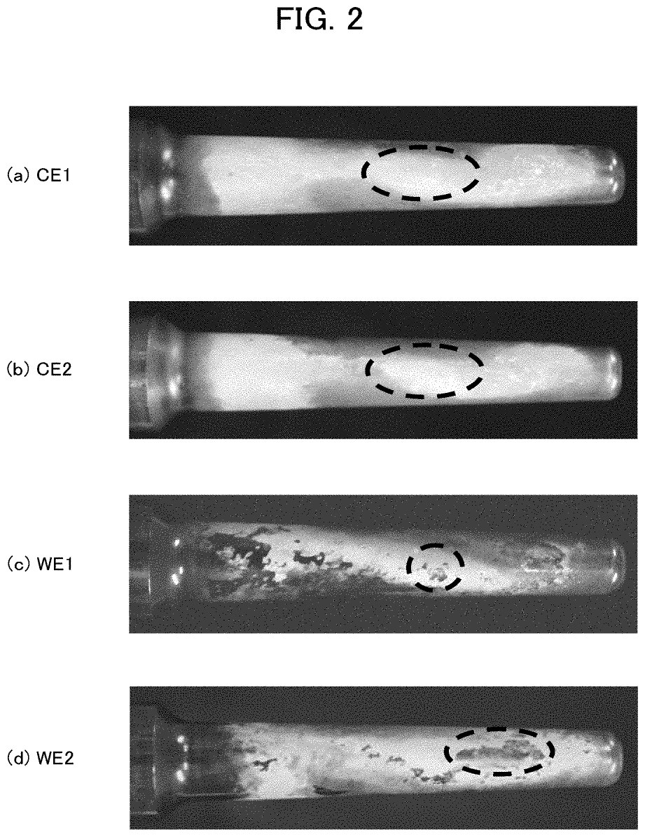

Moreover, photographs for showing states of aluminum alloy adhering to the surfaces of the various core pins of the samples CE1 and CE2 according to the comparative examples and the samples WE1 and WE2 according to the working examples of the present invention after the above-mentioned 90 shots of the die-casting process are shown in FIG. 2. In the samples CE1 and CE2 according to the comparative examples, a large amount of deposit (seizure) of aluminum alloy was observed in a region surrounded by a broken line shown in (a) and (b). On the other hand, in the samples WE1 and WE2 according to the working examples of the present invention, separation (dropout) of aluminum alloy which had once adhered (seized) to the surface was observed in a region surrounded by a broken line shown in (c) and (d). It is considered that this is because aluminum alloy which has once adhered (seized) to the surface is easily separated (dropped out) when a casted product is released from a mold, for example, while a die-casting process is being repeated, since peel force is small (namely, adhesive force of the aluminum alloy adhering (being seized) to the surface of the core pin is small) as for the samples WE1 and WE2 according to the working examples of the present invention as mentioned above.

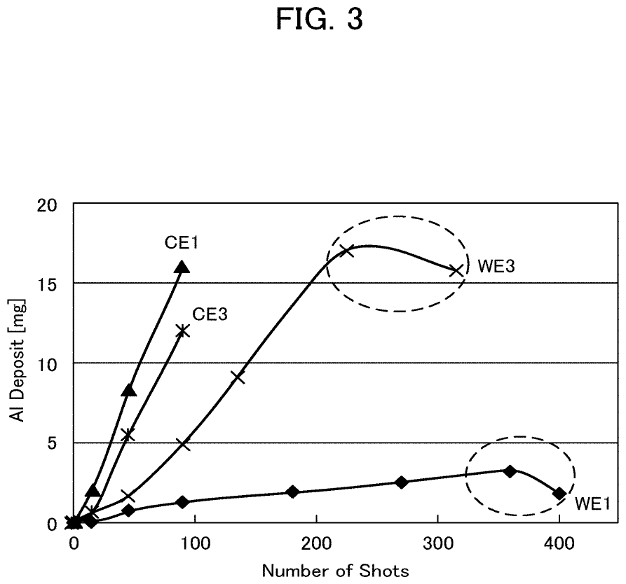

Furthermore, a schematic graph for showing a relation between number of shots and Al deposit in the above-mentioned evaluation of seizure resistance is shown in FIG. 3. In the samples CE1 and CE3 according to the comparative examples, the Al deposit monotonously increases in association with increase in the number of shots. On the contrary to this, in the samples WE1 and WE3 according to the working examples of the present invention, a rate of increase in the Al deposit in association with increase in the number of shots is small (inclination of the graph is gentle). Furthermore, when the number of shots is increased to more than 90, the Al deposit is decreasing in association with increase of the number of shots in a segment surrounded by a broken line. It is considered that this is because aluminum alloy which has once adhered (seized) to the surface is easily separated (dropped out) while a die-casting process is being repeated, since adhesive force of the aluminum alloy adhering (being seized) to the surface of the core pin is small as for the samples WE1 and WE2 according to the working examples of the present invention, as mentioned above.

In addition, as fro the samples WE1 to WE4 according to the working examples of the present invention, a tendency that the Al deposit increases as the content rate of silicon in the DLC coating increases is observed. This is considered to arise from that seizure resulting from the reaction of aluminum and silicon contained and atmospheric oxygen in a die-casting process increases as the content rate of silicon in the DLC coating increases. Therefore, it is desirable that the content rate of silicon in the DLC coating is as small as possible as long as the heat resistance (oxidation resistance) of the DLC coating can be sufficiently secured.

### <Heat Resistance>

As apparent from the above-mentioned evaluation results, the samples CE1 and CE2 according to the comparative examples with a conventionally used surface treatment and coating, have remarkably poor seizure resistance as compared with the samples other than them. Therefore, evaluation of heat resistance was carried out only on the samples CE3 and CE4 according to the comparative examples and the samples WE1 to WE4 according to the working examples of the present invention.

Specifically, the various test pieces of the samples CE3 and CE4 and the samples WE1 to WE4 were subjected to a heat treatment in the atmosphere for 1 hour at temperature of 400° C., and mass variations (amount of decrease) of the test pieces before and behind the heat treatment were calculated as mass decreases. The mass decreases measured in this way are also listed in Table 1.

The mass decrease was evaluated as “excellent” when being 0 (zero) mg, as “good” when being more than 0 (zero) mg and 0.05 mg or less, as “fair” when being 0.1 mg or less, and as “poor” when being more than 0.1 mg.

As shown in Table 1, the evaluation result of heat resistance was “good” only for the sample WE1 according to the working example of the present invention, and those were “excellent” for all of the samples WE2 to WE4 according to the other working examples of the present invention and the samples CE3 and CE4 according to the comparative examples. Thus, it has been confirmed that present invention component parts present heat resistance almost equivalent to the conventional component parts.

### <Overall Evaluation>

Based on the above-mentioned evaluation results of both seizure resistance and heat resistance, Overall evaluation was carried out for the samples CE1 to CE4 according to the comparative examples and the samples WE1 to WE4 according to the working examples of the present invention. Specifically, the lower one of the evaluation results of seizure resistance and heat resistance as an overall evaluation result. As a result, as shown in Table 1, the overall evaluation results were “excellent” to “good” for the samples WE1 to WE4 according to the working examples of the present invention, while those were “poor” to “fair” for the samples CE1 to CE4 according to the comparative examples.

From the above results, it has been confirmed that a component part for an aluminum die-casting mold which has excellent seizure resistance against molten metal containing aluminum can be provided in accordance with the present invention.

Although some the embodiments and working examples having specific configurations have been explained sometimes referring to the accompanying drawings as mentioned above, for the purpose of explaining the present invention, it should not be interpreted that the scope of the present invention is limited to these exemplary embodiments and working examples, and it is needless to say that any correction can be suitably added within the limits of the matters described in the claims and the specification.

### REFERENCE SIGNS LIST

1: Component Part for Aluminum Die-casting Mold (Pad of Sample), 2: Coating, and 3: Substrate.

1. A component part for an aluminum die-casting mold which has an exposed surface that is a surface exposed to a cavity part of the aluminum die-casting mold and has diamond-like carbon coating formed at least on a part of said exposed surface, wherein:
said diamond-like carbon coating contains hydrogen in a content rate of 10 at % or more and 30 at % or less.

2. The component part for an aluminum die-casting mold according to claim 1, wherein:
said diamond-like carbon coating further contains silicon in a content rate of less than 10 at %.

3. The component part for an aluminum die-casting mold according to claim 2, wherein:
the content rate of silicon in said diamond-like carbon coating is 0.5 at % or more and 7 at % or less.
